(19) United States
(12) Patent Application Publication
(10) Pub. No.: US 2025/0390417 A1
(43) Pub. Date: Dec. 25, 2025

(54) Live Testing of Event Processing Filters

(71) Applicant: PayPal, Inc., San Jose, CA (US)

(72) Inventors: Vinayak Chopra, New Delhi (IN); Sai Krishna Pinna, Hyderabad (IN); Pooja Garg, Ujjain (IN)

(21) Appl. No.: 18/748,594

(22) Filed: Jun. 20, 2024

(51) Int. Cl. G06F 11/36

(52) U.S. Cl. CPC G06F 11/3616; G06F 11/3612

(57) ABSTRACT

During a live test of changes to a current set of event processing filters, a computer system may determine a selected set of event processing filters with which to evaluate a live event (either a current set of event processing filters or a new set of event processing filters in one example). The computer system evaluates the live event according to the selected set of event processing filters. Based on the evaluation, the computer system updates metrics for events evaluated during the live test. The metrics may include a first set of metrics for events evaluated during the live test using the current set of event processing filters and a second set of metrics for events evaluated using the new set of event processing filters. The metrics may be used to decide whether to promote the new set of event processing filters to the current set of event processing filters.

### BACKGROUND

### Technical Field

This disclosure relates generally to processing of events by computer systems, and more particularly, to live testing of filters used to process such events.

### Description of the Related Art

Modern computer systems are particularly well-suited to processing large volumes of data and can frequently do so at a rate that allows real-time processing of data. For example, a computer system might receive data corresponding to a real-world phenomenon. The computer system could then evaluate the phenomenon using a computer model to assist in decision-making relating to the phenomenon. Common examples include determining whether computer network traffic constitutes a security threat, evaluating a search query, and processing data obtained from a biological sample.

To process data at scale with a minimum of processing time, computer systems commonly use software logic. For example, the software logic may include program instructions executable by the computer system to determine how to manipulate or route received data. Ideally, software logic is accurate and robust to correctly and efficiently facilitate data processing operations. The content of a given piece of software logic commonly changes over time, however. For example, changes in the nature of the incoming data might necessitate software logic modifications in some cases. In other situations, an entity operating a data processing system may decide to process the data differently from time to time, also leading to software logic modifications. Applicant recognizes a need to improve the handling of data events, particularly where those data events may be processed based on and/or affected by data received from an external source.

### BRIEF DESCRIPTION OF THE DRAWINGS

FIG. 1 illustrates one embodiment of an event processing system configured to effectuate a split-testing paradigm by processing live event data during a live test of changes to a current set of event processing filters.

FIG. 2A illustrates an example of filters, along with one embodiment of a filter management module.

FIG. 2B depicts an example of initiation of a live test of changes to a current set of event processing filters.

FIG. 2C illustrates one embodiment of a determination module, which is executable during a live test to determine which of the event processing filters is to be used to evaluate a particular live event.

FIG. 2D illustrates an organization of binning data when split parameter includes a single value.

FIG. 2E depicts binning module receiving a split parameter that includes two values.

FIG. 2F illustrates two examples of selection value generation for bins that have previously been configured.

FIG. 3 illustrates an example of evaluation, by evaluation module, of live event data according to a selected set of filters to generate evaluation data.

FIG. 4A illustrates one embodiment of an update module.

FIG. 4B illustrates one embodiment of a dashboard engine.

FIG. 5 illustrates, using a block diagram, an overall view of the splitting or partitioning that is performed by one embodiment of event processing system during a live test.

FIG. 6A depicts one example of a dashboard usable to configure a filter of filters.

FIG. 6B illustrates one example of a dashboard usable to establish and initiate a live test.

FIG. 7A illustrates one example of a dashboard configured to display metrics.

FIG. 7B illustrates one example of a dashboard configured to display metrics.

FIG. 8 is a flow diagram of one embodiment of a method for live testing of event processing filters.

FIG. 9 is a flow diagram of one embodiment of a method for live testing of event processing filters.

### DETAILED DESCRIPTION

For purposes of this disclosure, a computer system that receives data and then evaluates that data can be said to be an “event processing system.” A set of received data (e.g., a set of data that describes an occurrence such as a received set of IP packets in a computer system) can be referred to as an “event.” Software logic used to evaluate an event is referred to collectively as a set of event processing filters (EPFs). EPFs can be used, for example, to classify an event into one or multiple categories-for example, an event processing system that evaluates computer network traffic might use a set of EPFs to classify events as safe, malicious, or unknown.

Best practices for software engineering dictate that code modifications are to be carefully tested before release into a production environment. As is understood in the art, a software production environment refers to a computing environment running a latest version of software that is provided to the intended end users. A production environment stands in distinction to a testing environment running a version of the software that is not yet ready for general release. Accordingly, a production environment can be said to run against “live” events having live data. For example, a production environment for a computer system configured to detect malicious computer software would run against “live” (i.e., currently extant) threats, and uses of such a computer system would act upon results provided by the production environment.

Because it is not always desired to release software updates directly into a production environment without testing, an alternative is a “sandbox” testing environment in which the software logic modifications are tested in an environment that is not exposed to end users. Sandbox testing of a software update for a particular event processing system is commonly performed using historical data available to the event processing system, as opposed to live data. Consider an event processing system that performs computer security threat detection and that is operating in a production environment in May 2024. Such a system would thus be used to evaluate whatever security threats are currently extant in that month, including novel security threats that did not exist before May 2024. In contrast, a sandbox environment might use historical data (e.g., from Q4 of 2023) to evaluate potential changes to the production software.

During performance of some sandbox testing, a current version of software and an updated, to-be-tested version may both be used to evaluate events based on historical data. The outputs generated by each of the evaluations may then be compared. Based on the results of the comparison, the updated version of the software may be accepted or rejected. Acceptance of the updated version may constitute promoting the current version to a next level of testing or using the current version in the production environment, in various embodiments. Rejection of the updated version may involve further code revisions or discarding the updated version altogether.

While sandbox testing has its benefits, it can also be of limited utility for testing for release in a production environment in which the historical events used to perform the testing do not adequately reflect changes in the modeled phenomena that occurred after the time period in which the historical data was collected. For example, in the context of an update to software for computer virus detection event processing system, historical data will not include computer viruses that arose after the time period in which the historical data was collected.

Accordingly, sandbox testing results might, in some cases, suggest conclusions about the efficacy of the modified software that would not actually be true in a production environment. For example, sandbox testing might indicate that a particular software logic modification generates superior results to the unmodified software logic. For example, when tested on live event data a particular software logic modification tested only using sandboxed data might perform poorly (or not as well as the current software) due to changes in the modeled phenomena that occurred after collection of the historical data.

Another testing approach is to test the software logic modification on historical data and compare the results of this testing with results obtained from operating the unmodified software logic in a production environment. But the results of testing that uses historical data cannot always easily be compared to testing that uses live data. Accordingly, an “apples-to-apples” comparison cannot be made between the software logic modification tested on historical data and the unmodified software logic tested on live event data.

The inventors have thus recognized a need for improved testing of software logic modifications in event processing systems. To this end, the inventors propose live testing (i.e., in a production environment) in which live event data from a data stream is split into two or more sub-streams. One substream can have constituent live events evaluated according to the unmodified software logic (i.e., a current version of the software), while another substream can have constituent live events evaluated according to the modified software logic (i.e., an updated version of the software). Using this split testing paradigm, live event data obtained during a live event is split into two or more portions. A first portion of the live event data is evaluated using the unmodified software logic, while a second portion of the live event data is evaluated using the modified software logic. The system can then compute separate metrics for events evaluated in each of the substreams to determine whether the modified software logic results in acceptable evaluation of the events. In this manner, the software logic modification and the unmodified software logic can both be evaluated using live event data. This approach both allows the modified software to be tested on live event data and affords the ability to compare performance of the modified software to the unmodified software on the similar live event data.

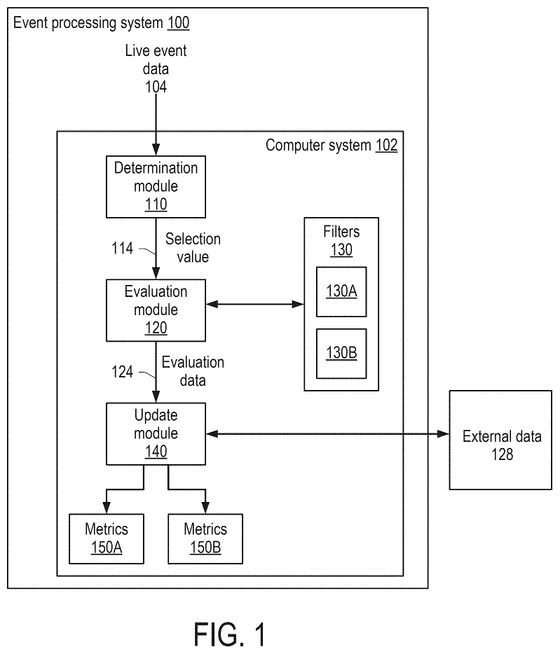

FIG. 1 illustrates one embodiment of event processing system 100 configured to effectuate this split-testing paradigm by processing live event data 104 during a live test of changes to current set of event processing filters 130A (current filters 130A). Event processing system 100 includes computer system 102. Computer system 102 includes a plurality of modules, such as determination module 110, evaluation module 120, and update module 140. “Module” refers to a set of software instructions that are executable by a computer system or computing device. Current filters 130A corresponds to one of a plurality of sets of event processing filters 130, collectively referred to as filters 130. The term “filter” is intended to broadly refer to any software logic, whether that logic is embodied in program instructions, a software rule usable by program instructions, or takes some other form.

FIG. 1 depicts split testing on live event data 104 of filters 130, which include current set of filters 130A and first new set of event processing filters 130B (new filters 130B). The designation of event processing filters 130 as a “first” new set of event processing filters indicates that more than one set of new filters may be tested during a single live test, as explained below. Current filters 130A correspond to unmodified software logic, and thus represent a current version of software used to perform event processing evaluation in event processing system 100. New filters 130B, on the other hand, correspond to a software logic modification (e.g., a modification to current filters 130A) and thus represent a modified version of the software.

During a live test of changes to current filters 130A, computer system 102 receives live event data 104 for events being processed by event processing system 100. Live event data 104 includes information for a plurality of events, each of which may consist of details of the event, which may be referred to as event metadata. For example, in the context of a computer security threat, event metadata might include an IP address of event origin and an IP address of event destination, as well as temporal parameters such as the time of the live event (e.g., a timestamp).

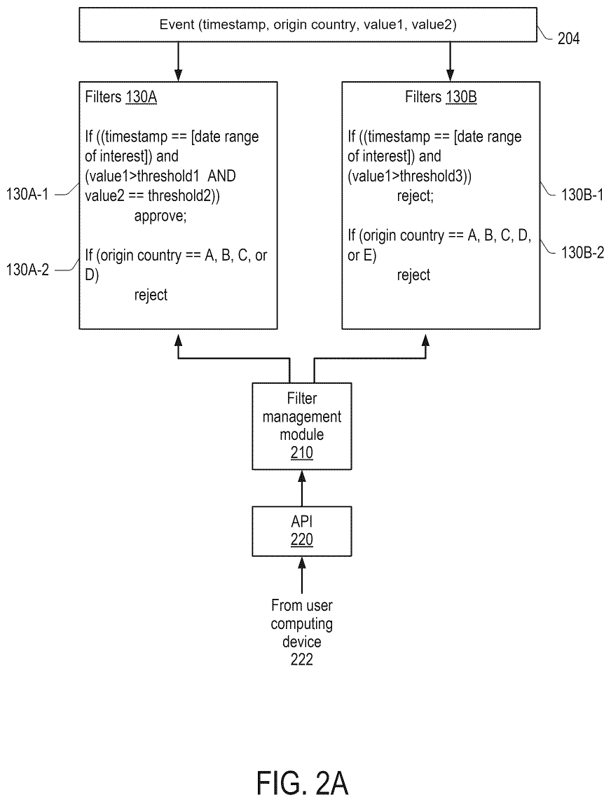

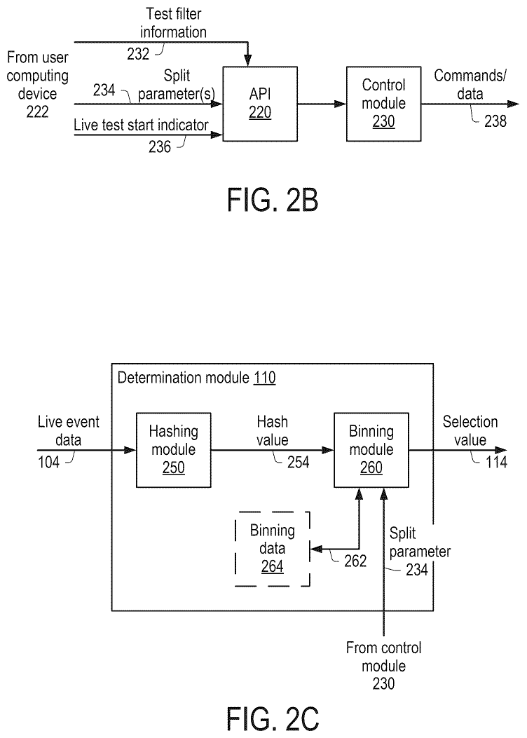

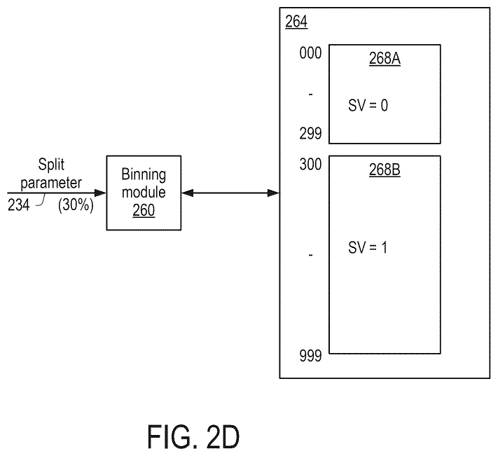

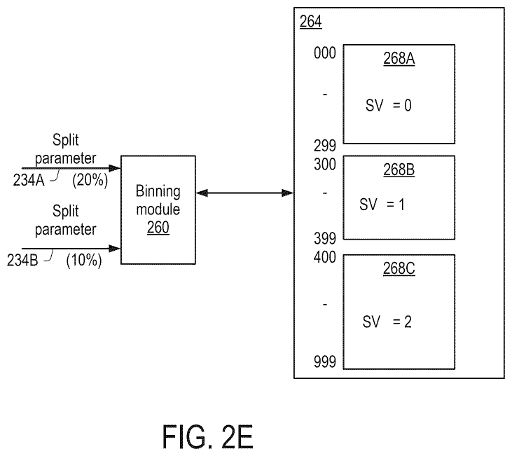

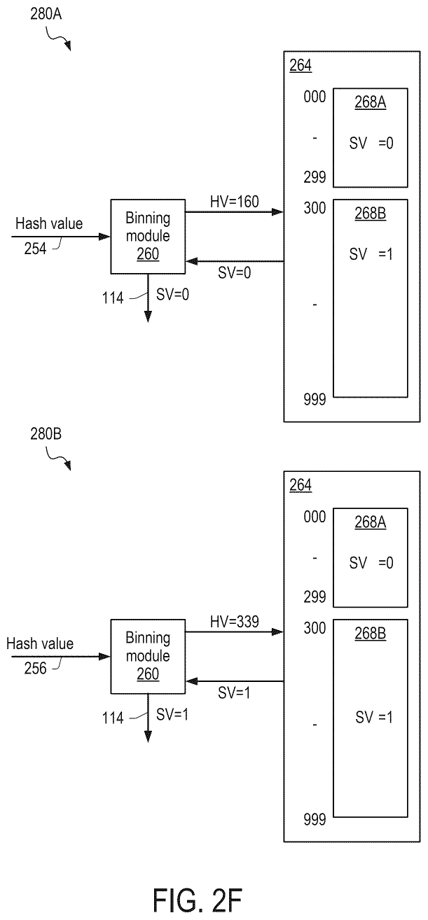

As depicted, live event data 104 is received by determination module 110, which is executable to determine which of a selected set of filters 130 will be used to evaluate a particular event within live event data 104. As will be described below with reference to FIGS. 2A-F, a user of event processing system 100 may supply a parameter that specifies a desired split in live event data 104 between current filters 130A and new filters 130B. For example, such a parameter might indicate that 90% of live event data 104 is to be processed using current filters 130A, while 10% is to be processed using new filters 130B. As will be described, determination module 110 is executable to generate a selection value 114 that is used to select the determined filters 130, in accordance, for example, with such a “split parameter.”

Evaluation module 120 is executable to evaluate live events in live event data 104 according to the selected set of filters 130 indicated by selection value 114. In the context of computer security testing, evaluation module 120 might be used, for example, to classify live events as malicious or safe (or possibly in a third category of “unknown” in some embodiments). The output of the evaluation process performed by evaluation module 120 is denoted as evaluation data 124, which is conveyed to update module 140. Notably, a given live event classified using different filters 130 might produce different results. It therefore follows that the set of live events in live event data 104 that are processed using current filters 130A might differ in outcomes and/or have different resulting characteristics/attributes than those processed using new filters 130B.

Accordingly, update module 140 is executable, using evaluation data 124, to update metrics that describe results and/or characteristics of live events evaluated during the live test. The metrics include first set of metrics 150A and second set of metrics 150B, collectively referred to as metrics 150. First set of metrics 150A correspond to a first set of metrics for events evaluated during the live test using current filters 130A. Second set of metrics 150B, on the other hand, correspond to a second set of metrics for events evaluated during the live test using new filters 130B. As shown, update module is also executable to update metrics 150 based on external data 128 that is received from sources external to event processing system 100. A comparison of metrics 150A and 150B can thus be used to determine whether new filters 130B represent an improvement over current filters 130A, for example.

Information within event processing system 100 may be stored in any suitable manner. In some embodiments, filters 130 are stored in a first database, while live event data 104 is stored in a second, different database. For example, the first database may be a MySQL database, while the second database may be a GCP Big Query database. In some cases, the second database is configured to store at least terabytes or petabytes of live event data 104, which may necessitate using a different type of data store than is used for filters 130. Because these databases may both be large in some instances, a software cache may be used to improve performance. In some embodiments, filters 130 selected by evaluation module 120 may be stored in the software cache to improve processing performance.

The approaches embodied in FIG. 1 and described further throughout the remainder this disclosure advantageously facilitate testing of a software logic modification such as new filters 130B on live event data 104. Filters 130 are tested on comparable, up-to-date data (instead of, for example, historical data), thereby mitigating testing risk by splitting live event data 104 into at least a first portion processed using current filters 130A and a second portion processed using new filters 130B. Accordingly, even if new filters 130B are harmful or ineffective, risk is mitigated, since only a portion of live event data 104 is processed using new filters 130B. Consequently, new filters 130B are tested in a real-world environment in a way that is easily compared to current filters 130A.

FIG. 2A illustrates an example of filters 130, along with one embodiment of filter management module 210. As shown, filters 130 include current filters 130A and new filters 130B, although an arbitrary number of filter sets can be used in different embodiments. Filters 130 may be used to process live event data 104, one example of which is shown in FIG. 2A as live event 204.

As an example, live event 204 may correspond to a network event in a computer network. Exemplary types of metadata for this event include a timestamp (e.g., when the event was received), an indication of a country of origin of the electronic communication corresponding to the event, and data values with an IP packet of the electronic communication (value 1 and value 2). Such components of live event 204 are merely exemplary to illustrate the possible operation of filters 130. In general, a live event may be associated with any number of types of metadata.

Current filters 130A include two rules (130A-1 and 130A-2), although in practice a filter set may include many such rules (e.g., hundreds or thousands). In the particular context of FIG. 2A, these rules are written to either “approve” or “reject” further processing of live event data 104. In general, rules may be used to classify events in any suitable manner—approval and rejection are only two possible classifications. Rule 130A-1 will cause live event 204 to be approved if its timestamp is within a date range of interest, value1 is greater than “threshold1” and value2 is equal to “threshold2.” Rule 130A-2, on the other hand, will cause live event 204 to be rejected if the country of origin is equal to any of countries, A, B, C, or D. Note that in various embodiments, once a rule makes a definitive classification (here, approve or reject), further rules may not be applied to live event 204. If no rules in filters 130A are applicable, some default action may be set to occur (e.g., default approval or default rejection). Note that the particular form of rules 130A-1 and 130A-2 are not meant to constrain the meaning of “filters” within this disclosure-that phrase is broad enough to include any type of logic embodied in software (for example, a neural network or other type of artificial intelligence). The rules in new filters 130B are similar to those in current filters 130A, with small changes in parameters.

Current filters 130A and new filters 130B are just two possible sets of filters that are usable by computer system 102. Accordingly, filter management module 210 can be used to manage these filters 130. To facilitate this filter management, filter management module 210 may receive input from user computing device 222 of a user of event processing system 100 input via application program interface (API) 220. This input can be used, for example, to promote new filters 130B to become current filters 130A if the performance of new filters 130B is deemed satisfactory. Input from user computing device 222 can also be used to perform other management functions, such as adding a new set of filters 130, deleting an existing set of filters 130, or editing content of an existing set of filters 130. In short, filter management module can be used by a user of event processing system 100 to control the content of the set of filters 130, as well as which set of filters 130 constitutes the current set that is to be used in a production environment.

FIG. 2B depicts an example of initiation of a live test of changes to current filters 130A. Control module 230, through API 220, is configured to receive, from user computing device 222, inputs to establish and initiate the live test. These inputs include test filter information 232, split parameter(s) 234 (split parameter 234), and live test start indicator 236. Based on the inputs, control module 230 is configured to generate commands/data 238 to cause computer system 102 to establish and/or initiate the live test. Establishing the live test includes setting up parameters that control how the live test will be performed, while initiating the live test causes the live test to begin, either immediately or at some specified time in the future.

Test filter information 232 indicates parameters associated with filters 130, in particular which filters will be part of the specified live test. In some instances, the current filters (e.g., 130A) are considered to be part of the live test, so test filter information might specify one or more additional filters to also be included as part of the test (e.g., 130B). As will be discussed, more than two filters might be utilized as part of the live test; accordingly, test filter information 232 will specify this.

Split parameter 234 refers to one or more values indicating a split of processing between the two or more filters involved in the live test. Note that split parameter 234 can include one or more values, which in some cases may be expressed as a percentage or a fraction between 0 and 1. A split parameter of 30%, for example, indicates to computer system 102 that 30% of live event data 104 received during the live test is to be processed by new filters 130B, with the result that the remaining 70% of live event data 104 received during the live test would be processed by current filters 130A. In some embodiments, if no split parameter 234 is specified, computer system 102 may be configured to apply a default value (e.g., stored in a memory of computer system 102) as split parameter 234. For instance, a default value may be 10%, denoting that 10% of live event data 104 is to be processed by new filters 130B. Processing live event data 104 by or in accordance with filters 130 means applying conditions, rules, or both associated with filters 130 to instances of live event data 104.

Further note that because a live test can be conducted with more than two filters 130, split parameter 234 can include more than one value—e.g., 10% and 20%. In such a case, a first portion of live event data 104 (10%) would be processed by a first new filter of new filters 130B and a second portion of live event data 104 (20%) would be processed by a second new filter of new filters 130B, with the result that the remaining 70% of live event data 104 would be processed by current filters 130A.

The use of split parameter 234 advantageously allows a user of event processing system 100 the ability to mitigate potential risk associated with the deployment of new filters. In other words, by specifying an upper-bound quantity of live event data 104 to be processed by new filters 130B, a situation is avoided in which an undesirable quantity of live event data 104 (e.g., a majority of live event data 104) is processed by new filters 130B. This ability to limit deployment is particularly useful since the use of new filters may have unintended consequences for a user of event processing system 100.

Live test start indicator 236 includes some indication of when and/or under what conditions a particular live test is to begin. In some implementations, live test start indicator 236 is simply an explicit command to begin the live test. In other cases, live test start indicator 236 may include temporal parameters associated with establishment of a live test. For example, live test start indicator 236 may indicate a timeframe during which a live test is to be performed, such as a start time/date and an end time/date associated with the performance of the live test. Additionally or alternatively, live test start indicator 236 may also include additional logical parameters that could be used as conditions for starting the live test—for example, instead of indicating that a live test should begin at Jun. 1, 2024 12 pm GMT, live test start indicator 236 might additionally specify that traffic being handled by event processing system 100 need be below some threshold in order to commence the live test.

While a user of user computer device 222 may specify one or more of test filter information 232, split parameter 234, or live test start indicator 236, in some embodiments, one or more of the foregoing may be automatically determined. For example, without input from a user, user computing device 222 may be configured, under certain conditions to automatically generate test filter information 232, split parameter 234, live test start indicator 236, or a combination thereof.

FIG. 2C illustrates one embodiment of determination module 110, which is executable during a live test to determine which of filters 130 is to be used to evaluate a particular live event. As shown, determination module 110 includes hashing module 250 and binning module 260. Determination module 110 is executable to access binning data 264, which, as indicated by the dashed lines, may be stored in one or more memories of computer system 102. Binning data 264 corresponds to a range of values, generated by computer system 102, such as a range of hash values as described with reference to FIGS. 2D and 2E.

As noted, when a live test is initiated, split parameter 234 specifies an indication of a desired split in processing by current filters 130A and new filters 130B. Determination module 110 uses hashing module 250 to help ensure that processing of the live events during the live test complies with the desired split (e.g., 90% processing by filters 130A, 10% processing by filters 130B).

As is understood in the art, hashing is a mathematical operation that is performed according to a hashing function to transform one value into a different value. Here, hashing is used to transform data associated with a live event into a value within a specified range (which, as will be described, corresponds to information in binning data 264). Because a hashing function can be designed to produce an even distribution of values throughout the specified range, it can advantageously be used to ensure that live event data 104 is processed by filters 130A-B in a manner that corresponds to the distribution specified by split parameter 234.

Hashing module 250 receives live event data 104 for a particular live event. Using information associated with live event data 104, hashing module 250 is executable to perform a hashing operation to generate hash value 254. In one embodiment, hashing module 250 can hash a timestamp included in live event data 104, but hashing can be performed on virtually any type of data. In one embodiment, the hashing operation performed by hashing module 250 is a modulo operation.

Consider a specific example of a hashing operation performable by hashing module 250. Event metadata included in or associated with live event data 104 may indicate a date range over which the live test is being performed. Hashing module 250 may be executable to calculate a number of days in the date range and may convert the number of days into milliseconds. Hashing module 250 may, for example, calculate the quantity of milliseconds corresponding to the number of days over which the live test occurs and to perform a modulo-1000 operation. Alternatively, a modulo operation may be performed on a timestamp that is part of the live event metadata.

While FIG. 2C describes that computer system 102 uses hashing to determine the selected set of event processing filters with which to evaluate the live event, other techniques could be implemented to do so. For example, computer system 102 may implement a random number generator to generate a random number that falls within a range of values corresponding to binning data 264. In general, hashing module 250 can be designed to generate values that are distributed (evenly distributed in an ideal case) within a specified range that corresponds to binning data 264. Binning module 260 is executable to calculate selection value (SV) 114, which will subsequently be used to select one of filters 130, using hash value (HV) 254 in conjunction with binning data 264. First, binning module 260 uses split parameter 234 received from control module 230 to set up binning data 264, as will be explained with reference to FIGS. 2D and 2E. Then, binning module 260 uses binning data 264 to perform a binning operation, as will be explained with reference to FIG. 2F.

FIG. 2D illustrates an organization of binning data 264 when split parameter 234 includes a single value, while FIG. 2E illustrates an organization of binning data 264 when split parameter 234 includes two values. Computer system 102 may implement the setup described with reference to FIGS. 2D-2E in response to receipt of commands/data 238 to set up a live test but before the live test is actually commenced.

As shown in FIG. 2D, binning data 264 may initially exist as a range of values—here 000 to 999. Note that this range of values corresponds to all possible values of hash value 254 that may be produced by hashing module 250. In response to receipt of split parameter 234, binning module 260 is executable to allocate a portion of the range of values to a particular bin, such that the ratio of the allocated portion to the total number of values in the overall range (i.e., 1000) corresponds to the value of split parameter 234. For example, when split parameter 234 indicates a 30% split for new filters 130B, binning module 260 is executable to allocate 30% of the 000-999 range (here, 000 to 299) to bin 268A, with the remaining 70% of the range (here, 300 to 999) to bin 268B. Accordingly, the desired live test split can be obtained by associating bin 268A with a selection value indicative of filters 130B, and associating bin 268B with a selection value indicative of filters 130A.

Next consider FIG. 2E, which depicts binning module 260 receiving a split parameter 234 that includes two values: 20% (value 234A) and 10% (value 234B). These values are interpreted to mean that 20% of live event data 104 is to be processed using first set of new filters 130B, 10% of live event data 104 is to be processing using second set of new filters 130C (not depicted), with the remaining 70% of live event data 104 to be processed using current filters 130A. Accordingly, binning module 260 allocates 20% of hash values (here, 000 to 199) to bin 268A, 10% of hash values (here, 200 to 299) to bin 268B, and the remaining 70% of hash values (here, 300 to 999) to bin 268C.

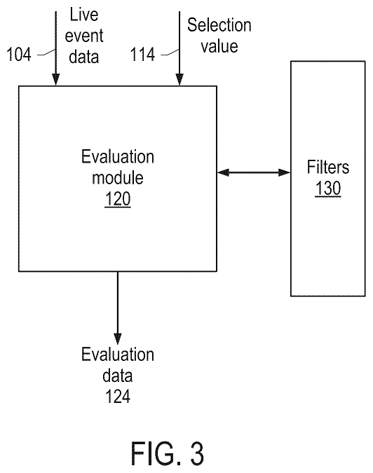

Additionally, binning module 260 is executable to assign SVs 114 to plurality of bins 268A-268C to facilitate filter retrieval as will be explained with reference to FIG. 3. For example, as depicted in FIG. 2D, hash value 254 will necessarily fall within the range 000-999, meaning that the hash value will be either associated with bin 268A or with bin 268B. The allocation of a selection value 114 to bins 268 (here, 0 or 1) allows placement in a bin to dictate a selection value, which in turn dictates a filter set 130. In FIG. 2E, on the other hand, there are three bins, which means there are three possible selection values 114 (e.g., 0, 1, 2).

FIG. 2F illustrates two examples of selection value generation for bins 268A-B that have previously been configured as described with reference to FIG. 2E. Example 280A results in an SV of 0, while example 280B results in an SV of 1. As previously described, binning module 260 generates a particular instance of SV 114 based on hash value (HV) 254.

In example 280A, binning module 260 receives the value 160 as HV 254. Accordingly, binning module 260 is executable to select bin 268A from plurality of bins 268A-268B, since bin 268A corresponds to bin data 264 associated with HVs 000-299, and HV 254 of 160 falls within the HV range of 000-299. Since bin 268A has an SV of 0, binning module 260 outputs an SV equal to 0. In this example, bin 268A is associated with new filters 130B, such that SV=0 is an indication to apply new filters 130B to that live event.

In example 280B, binning module 260 receives the value 339 as HV 254. Accordingly, binning module 260 is executable to select bin 268B from plurality of bins 268A-268B, since bin 268B corresponds to bin data 264 associated with HVs 300-999, and HV 254 of 339 falls within the HV range of 300-999. In this example, bin 268B is associated with current filters 130A, such that SV=1 is an indication to apply current filters 130B to that live event.

FIG. 3 illustrates an example of evaluation, by evaluation module 120, of live event data 104 according to a selected set of filters 130 to generate evaluation data 124. Evaluation module 120 receives SV 114 from determination module 110 and also receives live event data 104. Based on SV 114, evaluation module 120 is executable to select, from among filters 130, those filters 130 that correspond to SV 114. Additionally, evaluation module 120 is executable to process live event data 104 using the selected filters 130 to generate evaluation data 124.

For purposes of the discussion of this figure, assume that current filters 130A correspond to SV=1, while new filters 130B correspond to SV=0. Accordingly, evaluation module 120 will process live event data 104 using filters 130A if SV=1, and will process live event data 104 using filters 130B if SV=0. The process is similar if more than two sets of filters 130 are involved in the live test.

Generally, the particular set of filters 130 selected using SV 114 are used to process the data in some way. The particular form of data processing will vary depending on the nature of event processing system 100. In some cases, evaluation data 124 will correspond to a numerical output derived from information in live event 104 (e.g., 0-100, which may indicate a degree of risk in a software packet). In other cases, evaluation data 124 may be indicative of a classification of a live event. In a binary classification, evaluation data 124 may be either a 0 or 1. Any suitable type of ranges of values for evaluation data 124 is contemplated by this disclosure.

Additionally, note that what event processing system 100 does with evaluation data is similarly intended to be broad. In some cases, evaluation data 124 may be the final output of event processing system 100 for that live event. In other cases, however, evaluation data 124 may be a classification value that is used to determine how to handle the live event. For example, if evaluation data 124 is equal to 0, this may indicate to event processing system 100 to perform no further processing for a transaction corresponding to the live event. Conversely, if evaluation data 124 is equal to 1, this may indicate to event processing system 100 to complete processing for a transaction corresponding to the live event. There are many different possibilities for how event processing system 100 might use evaluation data 124 to handle live event data 104.

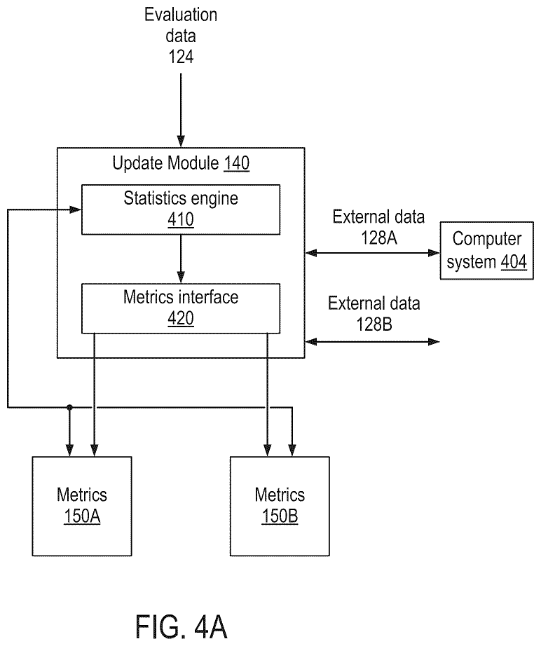

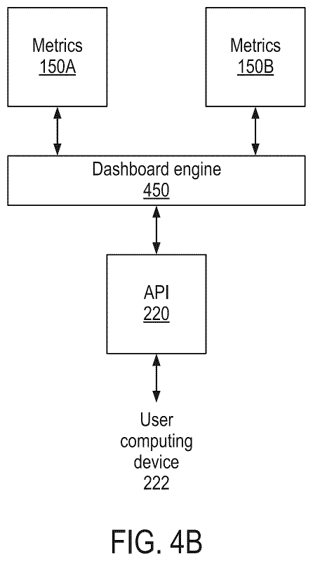

FIG. 4A illustrates one embodiment of update module 140. Update module 140 includes statistics engine 410 and metrics interface 420. Based on evaluation data 124, external data 128A, B (collectively “external data 128”), or both, update module 140 is executable to update metrics 150A, 150B for events evaluated during a live test.

External data 128A is information that relates to the live event generated external to event processing system 100 by computer system 404, while external data 128B is information regarding the live event that is received after conclusion of the live test but that may be generated by computer system 102 or other computing device associated with event processing system 100. Consider, for example, a live test in which modifications to computer security threat detection software corresponding to new filters 130B are tested on computer system 102 in comparison with unmodified computer security threat detection software corresponding to current filters 130A. In this context, metrics 150A, 150B (collectively “metrics 150”) may indicate a classification of live event data 104 as including malicious code, as being free from malicious code, or as necessitating further review (e.g., by other software, a human user, etc.).

In some implementations, however, it may be desirable to perform threat testing at a computer system external to computer system 102 (e.g., a system of a third party), such as at computer system 404. Such performance of external testing may make a determination about a particular threat that differs from that made by computer system 102. Computer system 404 may, for example, provide an indication of misclassification of the threat to computer system 102 as external data 128A. Accordingly, computer system 102 may update metrics 150. In one implementation, metrics 150 might include a specific measurement that indicates what percentage of all threats were misclassified by filters 130. This may be useful where the external testing is much more robust than that which can be provided by computer system 102 in real time or near real time. In some cases, external data 128A may arrive after conclusion of the live test (e.g., days or weeks after the live test has been completed). Nevertheless, metrics 150 may still be updated even though the live test is otherwise completed.

In contrast to external data 128A, external data 128B may be generated by computer system 102, by another computing device that is a component of event processing system 100, or both. For instance, a computing device that is a component of event processing system 100 may evaluate the threat to computer system 102, providing external data 128B to computer system 102 either while the live test is being performed by computer system 102 or after the live test has concluded.

Statistics engine 410 is software executable to generate statistics based on evaluation data 124, external data 128, or both. The statistics may include any known type of statistical information, such as variances, standard deviations, probability distributions, or the like. In some cases, statistics engine 410 may simply track a classification decision made by evaluation module 120 (e.g., whether a transaction corresponding to live event data 104 is approved, denied, etc.) Statistics engine 410 provides its output to metrics interface 420. Metrics interface 420 is software executable to generate metrics 150A and 150B based on the output of engine 410. In some embodiments, computer system 102 may be configured to compare first set of metrics 150A for the events evaluated during the live test using current filters 130A and second set of metrics 150B for the events evaluated during the live test. Note that metrics 150A and 150B correspond to different sets of data values-metrics 150A correspond to metrics for live event data 104 processed using current filters 130A, while metrics 150B correspond to metrics for live event data 104 processed using new filters 130B.

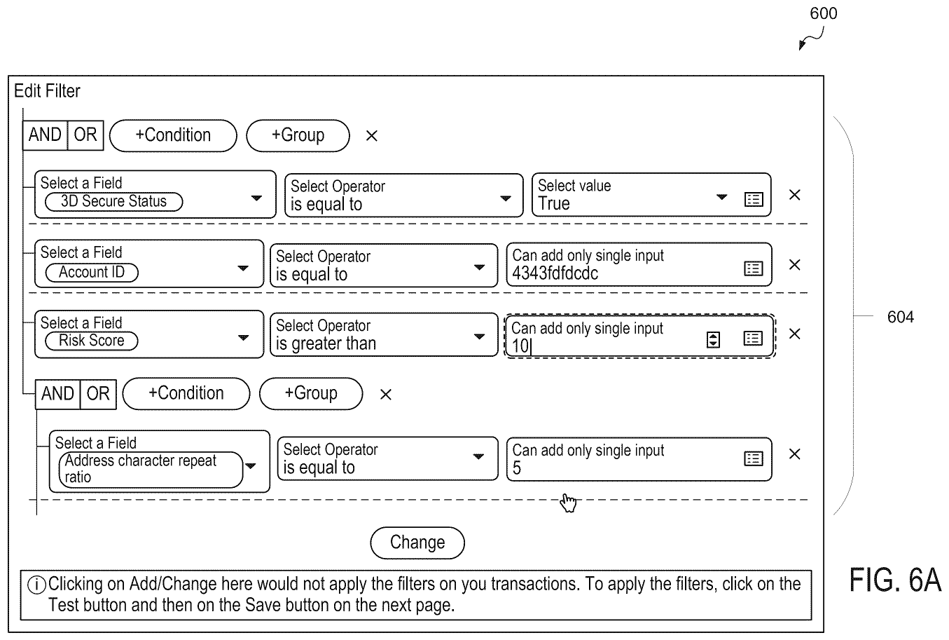

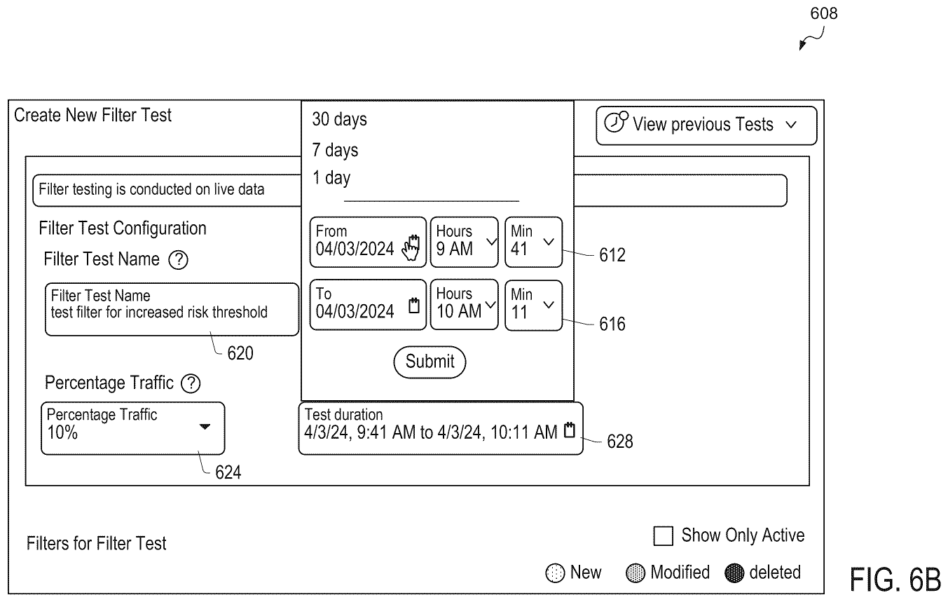

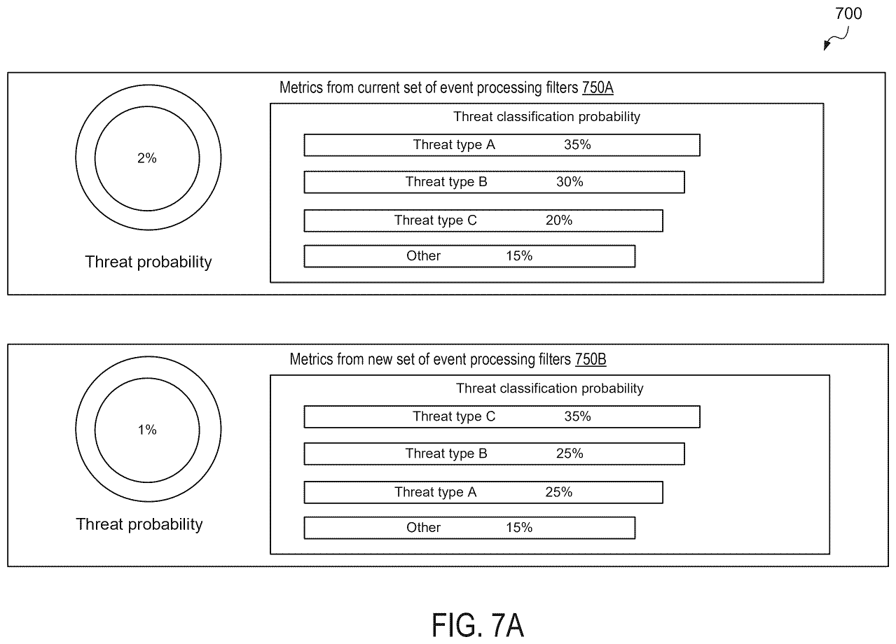

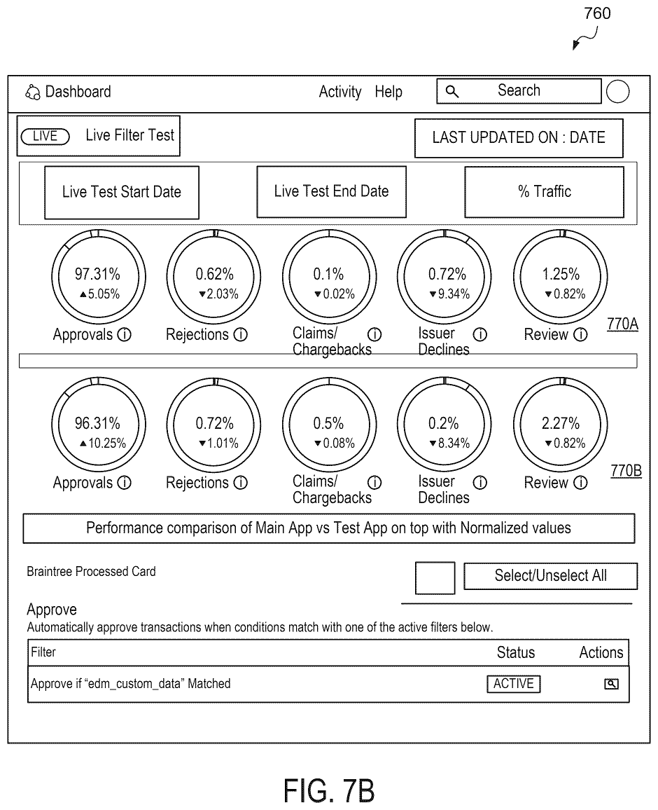

FIG. 4B illustrates one embodiment of dashboard engine 450. Dashboard engine 450 is software executable to gather information from metrics 150 usable to render a graphical user interface (GUI) on user computing device 222 via API 220. Dashboard engine 450 is executable to receive a request via API 220 from user computing device 222 to display metrics corresponding to a live test conducted by event processing system 100. This request may come, for example, from a user of event processing system 100 that is concerned with certain events being processed by the system (e.g., events to which the user is a participant). In this manner, the user may gather information about the efficacy of the changes made to filters 130A in filters 130B. Examples of GUIs that might be displayed on user computing device 222 are illustrated in FIGS. 6A-7B.

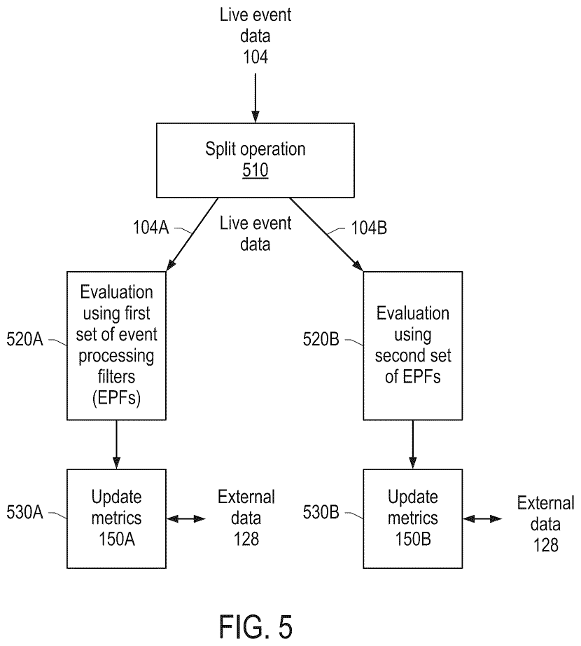

FIG. 5 illustrates, using a block diagram, an overall view of the splitting or partitioning that is performed by one embodiment of event processing system 100 during a live test. As depicted in FIG. 5, a stream of live event data 104 is split by a split operation 510 (performed by determination module 110 in one embodiment) into substreams 104A and 104B of live event data 104 throughout a timeframe during which the live test is being performed. Substreams 104A, 104B may also be referred to, respectively, as first set of live event data 104A and second set of live event data 104B. Event processing system 100 performs evaluation 520A on first set of live event data 104A using current filters 130A and performs evaluation 520B on second set of live event data 104B using new filters 130B. Collectively, evaluation 520A and evaluation 520B are referred to as evaluations 520. Additionally, event processing system 100 performs evaluations 520A and 520B to generate metrics 150A, 150B based on evaluations 520A and 520B. Update metrics 150A and 150B can also be updated based on external data 128 in addition to being updated based on evaluations 520.

Having described the overall operation of event processing system 100, the disclosure now turns to illustrating, with respect to FIGS. 6A-B and 7A-B, various examples of graphical user interfaces for communicating with event processing system 100.

FIG. 6A depicts one example of dashboard 600 usable to allow a user of event processing system 100 to configure one of filters 130. Computer system 102 may cause dashboard 600 to be rendered on user computing device 222. Code corresponding to dashboard 600 is executable to receive a user input via user computing device 222 based on a request received via API 220. For example, a user of user computing device 222 may include one or more rules 604 as part of a filter. The one or more rules 604 correspond to rules 130A-1, 130A-2, 130B-1, or 130B-2. Filter management module 210 receives the user input via dashboard 600 and is executable to configure the filter of filters 130 accordingly.

FIG. 6B illustrates one example of dashboard 608 usable to establish and initiate a live test. Computer system 102 may cause dashboard 608 to be rendered on user computing device 222 in response to a request received via API 220. Code corresponding to dashboard 608 is executable to initiate a live test based on various inputs specifiable via dashboard 608.

Dashboard 608 includes fields 612, 616, 628 that are operable to receive user input regarding timeframes associated with a live test. For example, field 612 is operable to receive, from a user, a start date and a start time of the live test and field 616 is operable to receive, from the user, an end date and an end time of the live test. Field 628 is operable to receive, from the user, an indication of a duration of the live test, such as a number of days, hours, weeks, months, etc. for which the live test is to occur. Field 620 is operable to receive, from the user, an indication of which filter of filters 130 is to be applied to process live event data 104. Field 624 is operable to receive, from the user, a value corresponding to split parameter 234.

FIG. 7A illustrates one example of dashboard 700 configured to display metrics 750A, 750B, which correspond to metrics 150A, 150B. Computer system 102 may cause dashboard 700 to be rendered on user computing device 222.

As has been noted, event processing system 100 can be used for any suitable type of application. Dashboard 700 may be generated, for example, in the context of computer security threat detection. In this context, user computing device 222 may be associated with a system administrator, tasked with identifying threats to a computer network, such as malicious code included in data received at or processed by the computer network. The system administrator might initiate a live test of new filters 130B that may correspond to modifications to computer security threat detection rules usable to identify malicious code in the received live event data 104. One purpose of performing the live test may be to determine whether the new filters 130B are better able to identify malicious content in live event data 104 relative to current filters 130A.

By comparing metrics 750A, generated by processing live event data 104 using current filters 130A with metrics 750B generated by processing live event data 104 using new filters 130B, the system administrator may identify whether new filters 130B are better able to identify malicious code than are current filters 130A. For instance, as depicted in FIG. 7A, new filters 130B may identify that 1% of live event data 104 includes malicious code, while current filters 130A may identify that 2% of live event data 104 includes malicious code. Based on comparing metrics 750A and 750B, the system administrator may conclude that, relative to current filters 130A, new filters 130B are inferior at detecting malicious code in live event data 104. Accordingly, the system administrator may not replace current filters 130A with new filters 130B.

In some embodiments, the comparison of metrics 750A-B may be automated. For example, computer system 102 may use software to compare metrics 750A and 750B. In response to determining, based on the comparison, that new filters 130B are inferior to current filters 130A, computer system 102 may maintain current filters 130A. Conversely, if based on the comparison, computer system 102 were to determine that new filters 130B are superior to current filters 130A, computer system 102 may be configured to replace current filters 130A with new filters 130B. It is to be noted that dashboards similar to dashboard 700 might apply to various other contexts, including an epidemiological one in which biological data indicative of a presence of disease in a population is received.

FIG. 7B illustrates one example of dashboard 760 configured to display metrics 770A-B, which correspond to metrics 150A-B. Computer system 102 may cause dashboard 760 to be rendered on user computing device 222 in response to a request via API 220.

Dashboard 760 may be generated, for example, in the context of detection of anomalies, such as fraud, in electronic financial transactions. In this context, user computing device 222 may be associated with a merchant that sells products, services, or both over a network, such as the Internet. Event processing system 100 may thus be a payment processing service used by the merchant to evaluate the electronic financial transactions. For instance, computer system 102, executing payment processing software, may receive electronic financial transaction data from the merchant computer system (e.g., user computing device 222). Computer system 102, in some embodiments, may approve certain transactions corresponding to the electronic financial transaction data, reject some of the transactions, flag some of the transactions for further review, or a combination thereof. Approving a transaction in this context means that the transaction may proceed such that the merchant provides the requested product or service to the prospective buyer in exchange for receiving payment. Rejecting a transaction means that the transaction may not proceed such that the merchant does not provide the requested product or service to the prospective buyer. Flagging a transaction for further review means that a transaction is indicated as necessitating further analysis, either through automated means, by human review, or both. Additionally, while computer system 102 might initially approve certain of these transactions, subsequently, these transactions might be rejected. Such subsequent rejection of previously approved transactions may be referred to as claims/chargebacks, and the merchant usually assumes the financial loss associated with these claims/chargebacks. Further, in some cases, a third party, such as a credit card or debit card issuer, might subsequently decline approved transactions if the third party determines that the transaction is fraudulent or is likely to be fraudulent. Such third-party declined transactions may be referred to as issuer declines or issuer-declined transactions. Computer system 102 may receive data indicating the occurrence of these claims/chargebacks, issuer declines, or both as external data 128. This type of external data 128 may be received days, weeks, months, or some other time interval, after the payment processing software has approved the subsequently rejected transaction.

To experiment with one or more modifications to payment processing rules that correspond to new filters 130B while mitigating financial exposure incurred by new filters 130B that exhibit poor performance relative to the unmodified payment processing rules corresponding to current filters 130A, a merchant might initiate, via user computing device 222, a live test of new filters 130B. During such a live test, computer system 102, executing the unmodified payment processing rules as current filters 130A and the modified payment processing rules as new filters 130B, may receive, from user computer device 222 for example, live event data 104 corresponding to financial transactions.

Current filters 130A may process a first portion of live event data 104 while new filters 130B may process a second portion of live event data 104 in accordance with split parameter 234 as explained with reference to FIGS. 2B-3. Based on the processing, some transactions associated with live event data 104 may be approved, others may be rejected, and still others may be identified as necessitating further review as indicated by metrics 770A, 770B. Differences between current filters 130A and new filters 130B, such as different rules being tested in new filters 130B that are not also included in current filters 130A result in differences between metrics 770A generated by processing live event data 104 using current filters 130A and metrics 770B generated by processing live event data using new filters 130B.

Additionally, for each of live event data 104 processed by current filters 130A and new filters 130B, computer system 102 may receive external data 128, such as data corresponding to claims/chargebacks and issuer declines and updates metrics 770A, 770B accordingly. Such live event data 104 may be received from computer systems external to event processing system 100, during a timeframe after conclusion of the live test, or both. For instance, external data 128 corresponding to claims/chargebacks may be received from a third party computer system and in some cases may be received after conclusion of the live test. As another example, external data 128 corresponding to issuer declines may be received from a computer system operated by a financial institution, such as a bank, a credit card company, or the like and may be received months after conclusion of the live test.

Based on a comparison of metrics 770A-B, a determination can be made as to whether to promote new filters 130B as current filters 130A. For example, in response to the comparison indicating that new filters 130B more accurately identify anomalous financial transactions as compared with current filters 130A, new filters 130B may be promoted to replace current filters 130A. Conversely, in response to the comparison indicating that new filters 130B more accurately identify anomalous financial transactions as compared with current filters 130A, new filters 130B may rejected in favor of maintaining current filters 130A. In some embodiments, this comparison may be performed automatically, such as by computer system 102 executing the payment processing software.

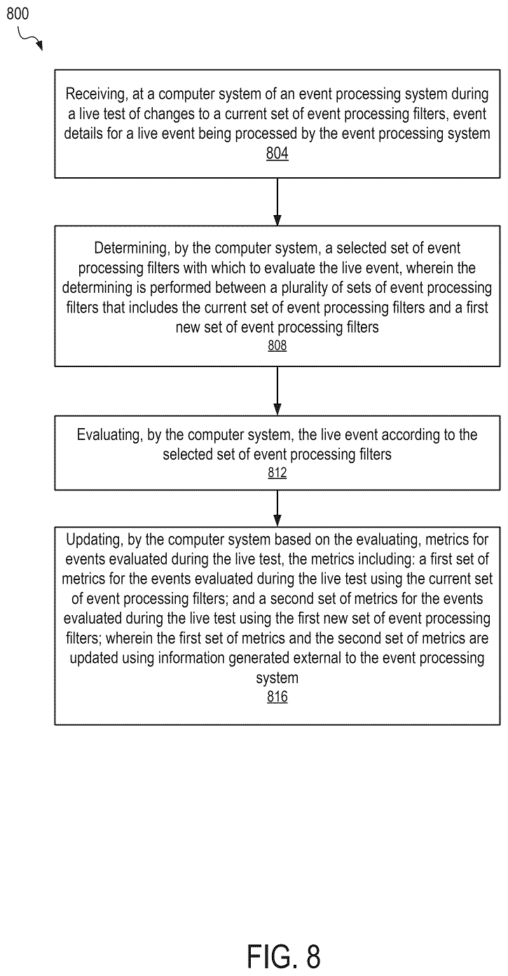

FIG. 8 is a flow diagram of one embodiment of method 800 for live testing of event processing filters. Method 800 may be performed by a computer system of an event processing system. For example, method 800 may be performed by computer system 102 of event processing system 100. Method 800 has many possible variations, some of which are described below.

At 804, a computer system of an event processing system receives, during a live test of changes to a current set of event processing filters, event details for a live event being processed by the event processing system. For example, computer system 102 receives, during a live test of changes to current filters 130A, event details for a live event being processed by event processing system 100.

At 808, the computer system determines a selected set of event processing filters with which to evaluate the live event, wherein the determining is performed between a plurality of sets of event processing filters that includes the current set of event processing filters and a first new set of event processing filters. For example, computer system 102 may determine selected set of filters 130 with which to evaluate live event data 104 as described with reference to FIGS. 2C-3. Computer system 102 may thus determine the selected set of filters from filters 130 that include current filters 130A and new filters 130B.

In some embodiments, the selected set of event processing filters includes a particular event processing filter that is not present in any of remaining ones of the plurality of sets of event processing filters. For example, filters 130 selected by evaluation module 120 to process live event data 104 may include a particular filter (e.g., one of current filters 130A, one of new filters 130B, or both) that is not present in any of remaining ones of the plurality of filters 130.

In some embodiments, to determine the selected set of processing filters for the live event, the computer system is configured to hash metadata in the event details into a particular one of a plurality of bins corresponding to the first new set of processing filters. For example, to determine selected set of processing filters 130 for the live event, hashing module 250 of determination module 110 may be configured to hash metadata in the event details into a particular one of a plurality of bins (e.g., bin 268A of FIG. 2D, bins 268A, 268B of FIG. 2E) corresponding to new filters 130B. In some embodiments, a size of the particular bin is determined based on the specified split parameter. For example, a size of particular bin 268A may be determined based on split parameter 234.

At 812, the computer system evaluates the live event according to the selected set of event processing filters. For example, evaluation module 120 of computer system 102 may be executable to evaluate live event data 104 according to the selected set of filters 130 as described with reference to FIG. 3.

In some embodiments, to evaluate the live event, the computer system determines whether to allow a transaction based on the live event to be processed based on results of applying the selected set of event processing filters to the live event. For example, evaluation module 120 of computer system 102 may determine whether to allow transactions associated with live event data 104 to be processed based on evaluation data 124 generated through application, by evaluation module 120, of filters 130 to live event data 104.

At 816, the computer system updates, based on the evaluating, metrics for events evaluated during the live test, the metrics including a first set of metrics for the events evaluated during the live test using the current set of event processing filters and a second set of metrics for the events evaluated during the live test using the first new set of event processing filters, wherein the first set of metrics and the second set of metrics are updated using information generated external to the event processing system. For example, update module 140 of computer system 102 may be executable to update metrics 150A, 150B for events evaluated during the live test. The metrics may, for example, include first set of metrics 150A evaluated during the live test using current filters 130A. Additionally, the metrics may, for instance, include second set of metrics 150B for the events evaluated during the live test using new filters 130B. Metrics 150A and 150B may, for example, be updated using external data 128.

In some embodiments, over a duration of the live test, the computer system splits a stream of live events that includes the live event into at least two sub-streams that includes a first sub-stream evaluated according to the current set of event processing filters and a second sub-stream evaluated according to the first new set of event processing filters. For example, computer system 102 may split live event data 104 that includes or is associated with the live event into at least two sub-streams that include a first sub-stream evaluated according to current filters 130A and a second sub-stream evaluated according to new filters 130B.

In some embodiments, the stream is split according to a specified split parameter. For example, computer system 102 is configured to split live event data 104 according to split parameter 234.

In some embodiments, the computer system receives, from a computing device of a user of the event processing system, a request to render, on the computing device, a dashboard that displays visual representations of the first set of metrics and the second set of metrics. For example, computer system 102 may receive, from user computing device 222, a request to render, on user computing device 222, dashboard 600, 608, 700, 760, or any combination thereof that that displays visual representations of first set of metrics 150A and second set of metrics 150B.

In some embodiments, the computer system receives, from a computing device of a user of the event processing system, an indication to promote the first new set of event processing filters to become the current set of event processing filters. For example, computer system 102 may receive, from computing device 222, an indication to promote new filters 130B to become current filters 130A.

In some embodiments, the plurality of sets of event processing filters includes a second new set of event processing filters, the metrics including a third set of metrics for events evaluated during the live test using the second new set of events processing filters. For example, filters 130 may include a second set of new filters 130B, and the metrics may include a third set of metrics for live event data 104 evaluated during the live test using the set of new filters 130B.

In some embodiments, the computer system makes further updates to the metrics based on information regarding the live event that is received after conclusion of the live test. For example, computer system 102 makes further updates to metrics 150A, 150B based on information regarding the live event that is received after conclusion of the live test.

Method 800 is intended to be broadly applicable. In some embodiments, the event processing system is a system configured to classify computer security alerts within a computer network, the live event corresponding to a particular security event. For example, as described with reference to FIG. 7A, event processing system 100 may be configured to classify computer security alerts with a computer network, the live event corresponding to a particular security event such as live data 104 that includes one or more computer viruses. In other embodiments, the event processing system is a system configured to evaluate e-commerce transactions, the live event corresponding to a particular e-commerce transaction. For example and as described with reference to FIG. 7B, event processing system 100 may be a system configured to evaluate e-commerce transactions in which each instance of live event data 104 corresponds to a particular e-commerce transaction.

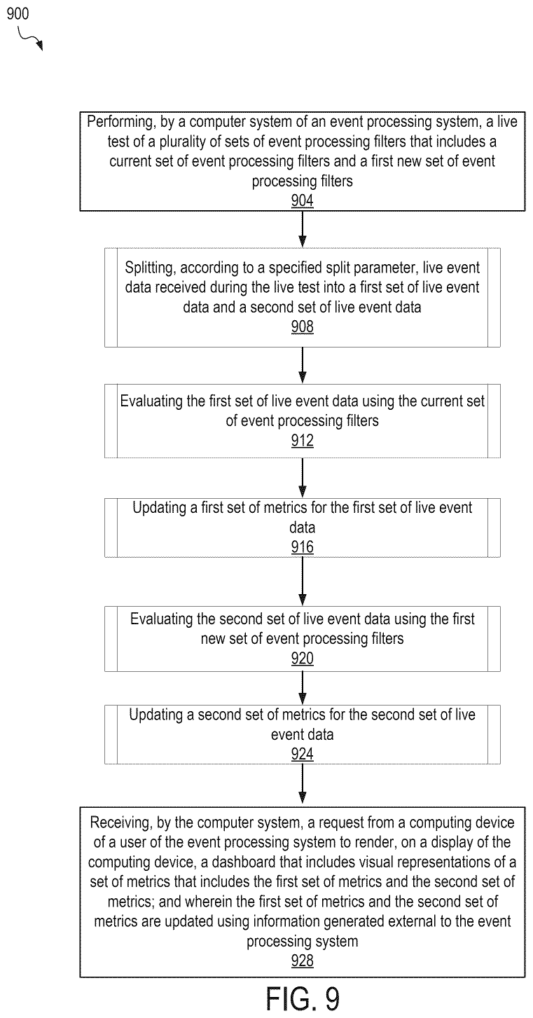

FIG. 9 is a flow diagram of one embodiment of method 900 for live testing of event processing filters. Method 900 may be performed by a computer system of an event processing system. For example, method 900 may be performed by computer system 102 of event processing system 100. Method 900 has many variations, including those described below.

At 904, the computer system of the event processing system performs a live test of a plurality of sets of event processing filters that includes a current set of event processing filters and a first new set of event processing filters. For example, computer system 102 of event processing system 100 may perform a live test of filters 130 that includes current filters 130A and new filters 130B.

To perform the live test, at 908, the computer system splits, according to a specified split parameter, live event data received during the live test into a first set of live event data and a second set of live event data. For example, computer system 102 may split, according to split parameter 234, live event data 104 received during the live test into first set of live event data 104A and into second set of live event data 104B.

In some embodiments, to split the live event data, the computer system receives, during the live test, particular live event data for a particular live event. For example, to perform split operation 510, computer system 102 may receive, during the live test, particular live event data 104 for a particular live event. Additionally, in some embodiments, to split the live event data, the computer system hashes metadata in the particular live event data into a particular one of a plurality of bins corresponding to the plurality of sets of event processing filters. For example, to split live event data 104, computer system 102 may hash metadata in particular live event data 104 into a particular one of a plurality of bins 268A, 268B, or 268C as explained with reference to FIGS. 2C-2F. In some embodiments, the particular bin indicates which set of event processing filters is to be used to evaluate the particular live event. For example, the particular bin 268A, 268B, or 268C may indicate whether current filters 130A or new filters 130B are to be used to evaluate particular live event data 104. In some embodiments, the hashing is performed to achieve a percentage distribution of live event data that is indicated by the specified split parameter. For example, the hashing may be performed to achieve a percentage distribution of live event data 104 indicated by split parameter 234.

Additionally, to perform the live test, at 912, the computer system evaluates the first set of live event data using the current set of event processing filters. For example, computer system 102 may evaluate first set of live event data 104A using current filters 130A.

In some embodiments, to evaluate the first set of live event data, the computer system determines whether to process transactions corresponding to live events in the first set of live event data using the current set of event processing filters. For example, to evaluate first set of live event data 104A, computer system 102 may determine whether to process transactions corresponding to live events in first set of live event data 104A using current filters 130A.

Further, to perform the live test, at 916, the computer system updates a first set of metrics for the first set of live event data. For example, computer system 102 may update metrics 150A for first set of live event data 104A.

Moreover, to perform the live test, at 920, the computer system evaluates the second set of live event data using the first new set of event processing filters. For example, computer system 102 may evaluate second set of live event data 104B using new filters 130B.

In some embodiments, to evaluate the second set of live event data, the computer system determines whether to process transactions corresponding to live events in the second set of live event data using the first new set of event processing filters. For example, to evaluate second set of live event data 104B, computer system 102 may determine whether to process transactions corresponding to live events in second set of live event data 104B using the new filters 130B.

Additionally, to perform the live test, at 924, the computer system updates a second set of metrics for the second set of live event data. For example, computer system 102 may update second set of metrics 150B for second set of live event data 104B.

At 928, the computer system receives a request from a computing device of a user of the event processing system to render, on a display of the computing device, a dashboard that includes visual representations of a set of metrics that includes the first set of metrics and the second set of metrics; and wherein the first set of metrics and the second set of metrics are updated using information generated external to the event processing system. For example, computer system 102 may receive a request from user computing device 222 to render, on a display of user computing device 222, dashboard 600, 608, 700, 760, or any combination thereof that includes visual representations of a set of metrics that includes first set of metrics 150A and second set of metrics 150B. As another example, first set of metrics 150A and second set of metrics 150B are updated using information generated external to event processing system 100. Such external information may correspond to external data 128.

In some embodiments, the plurality of sets of event processing filters includes a second new set of event processing filters. For example, filters 130 may include a second new set of event processing filers as new filters 130B. In some embodiments, to perform the live test, the computer system splits, according to the specified split parameter, live event data received during the live test into the first set of live event data, the second set of live event data, and a third set of live event data. For example, computer system 102 may split, according to one or more split parameters 234, live event data 104 into first set of live event data 104A, second set of live event data 104B, and a third set of live event data. In some embodiments, to perform the live test, the computer system evaluates the third set of live event data using the second new set of event processing filters. For example, to perform the live test, computer system 102 may evaluate the third set of live event data using a second set of new filters 130B. In some embodiments, to perform the live test, the computer system updates a third set of metrics for the third set of live event data. For example, to perform the live test, computer system 102 may update a third set of metrics for the third set of live event data.

In some embodiments, the computer system updates, after the live test has ended, the first set of metrics and the second set of metrics with additional information about live events in the live test. For example, computer system 102 may update, after the live test has ended, first set of metrics 150A and second set of metrics 150B with additional information about live events in the live test.

Various techniques described herein, including methods 800 and 900, may be performed by one or more computer programs. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.). Program instructions embodied on a non-transitory computer-readable storage medium are explicitly contemplated for any disclosed method, including methods 800 and 900.

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

Similarly, systems that implement the methods described with respect to any of the disclosed techniques are also contemplated. One such environment in which the disclosed techniques may operate is a cloud computer system. A cloud computer system (or cloud computing system) refers to a computer system that provides on-demand availability of computer system resources without direct management by a user. These resources can include servers, storage, databases, networking, software, analytics, etc. Users typically pay only for those cloud services that are being used, which can, in many instances, lead to reduced operating costs. Various types of cloud service models are possible. The Software as a Service (SaaS) model provides users with a complete product that is run and managed by a cloud provider. The Platform as a Service (PaaS) model allows for deployment and management of applications, without users having to manage the underlying infrastructure. The Infrastructure as a Service (IaaS) model allows more flexibility by permitting users to control access to networking features, computers (virtual or dedicated hardware), and data storage space. Cloud computer systems can run applications in various computing zones that are isolated from one another. These zones can be within a single or multiple geographic regions.

A cloud computer system includes various hardware components along with software to manage those components and provide an interface to users. These hardware components include a processor subsystem, which can include multiple processor circuits, storage, and I/O circuitry, all connected via interconnect circuitry. Cloud computer systems thus can be thought of as server computer systems with associated storage that can perform various types of applications for users as well as provide supporting services (security, load balancing, user interface, etc.).

One common component of a cloud computing system is a data center. As is understood in the art, a data center is a physical computer facility that organizations use to house their critical applications and data. A data center's design is based on a network of computing and storage resources that enable the delivery of shared applications and data.

The term “data center” is intended to cover a wide range of implementations, including traditional on-premises physical servers to virtual networks that support applications and workloads across pools of physical infrastructure and into a multi-cloud environment. In current environments, data exists and is connected across multiple data centers, the edge, and public and private clouds. A data center can frequently communicate across these multiple sites, both on-premises and in the cloud. Even the public cloud is a collection of data centers. When applications are hosted in the cloud, they are using data center resources from the cloud provider. Data centers are commonly used to support a variety of enterprise applications and activities, including, email and file sharing, productivity applications, customer relationship management (CRM), enterprise resource planning (ERP) and databases, big data, artificial intelligence, machine learning, virtual desktops, communications and collaboration services.

Data centers commonly include routers, switches, firewalls, storage systems, servers, and application delivery controllers. Because these components frequently store and manage business-critical data and applications, data center security is critical in data center design. These components operate together provide the core infrastructure for a data center: network infrastructure, storage infrastructure and computing resources. The network infrastructure connects servers (physical and virtualized), data center services, storage, and external connectivity to end-user locations. Storage systems are used to store the data that is the fuel of the data center. In contrast, applications can be considered to be the engines of a data center. Computing resources include servers that provide the processing, memory, local storage, and network connectivity that drive applications. Data centers commonly utilize additional infrastructure to support the center's hardware and software. These include power subsystems, uninterruptible power supplies (UPS), ventilation, cooling systems, fire suppression, backup generators, and connections to external networks.

Data center services are typically deployed to protect the performance and integrity of the core data center components. Data center therefore commonly use network security appliances that provide firewall and intrusion protection capabilities to safeguard the data center. Data centers also maintain application performance by providing application resiliency and availability via automatic failover and load balancing.

One standard for data center design and data center infrastructure is ANSI/TIA-942. It includes standards for ANSI/TIA-942-ready certification, which ensures compliance with one of four categories of data center tiers rated for levels of redundancy and fault tolerance. A Tier 1 (basic) data center offers limited protection against physical events. It has single-capacity components and a single, nonredundant distribution path. A Tier 2 data center offers improved protection against physical events. It has redundant-capacity components and a single, nonredundant distribution path. A Tier 3 data center protects against virtually all physical events, providing redundant-capacity components and multiple independent distribution paths. Each component can be removed or replaced without disrupting services to end users. A Tier 4 data center provides the highest levels of fault tolerance and redundancy. Redundant-capacity components and multiple independent distribution paths enable concurrent maintainability and one fault anywhere in the installation without causing downtime.

Many types of data centers and service models are available. A data center classification depends on whether it is owned by one or many organizations, how it fits (if at all) into the topology of other data centers, the technologies used for computing and storage, and its energy efficiency. There are four main types of data centers. Enterprise data centers are built, owned, and operated by companies and are optimized for their end users. In many cases, they are housed on a corporate campus. Managed services data centers are managed by a third party (or a managed services provider) on behalf of a company. The company leases the equipment and infrastructure instead of buying it. In colocation (“colo”) data centers, a company rents space within a data center owned by others and located off company premises. The colocation data center hosts the infrastructure: building, cooling, bandwidth, security, etc., while the company provides and manages the components, including servers, storage, and firewalls. Cloud data centers are an off-premises form of data center in which data and applications are hosted by a cloud services provider such as AMAZON WEB SERVICES (AWS), MICROSOFT (AZURE), or IBM Cloud.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” be used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112 (f) during prosecution of a United States patent application based on this disclosure, it will recite claim elements using the “means for” [performing a function] construct.

What is claimed is:

1. A method comprising:
receiving, at a computer system of an event processing system during a live test of changes to a current set of event processing filters, event details for a live event being processed by the event processing system;
determining, by the computer system, a selected set of event processing filters with which to evaluate the live event, wherein the determining is performed between a plurality of sets of event processing filters that includes the current set of event processing filters and a first new set of event processing filters;
evaluating, by the computer system, the live event according to the selected set of event processing filters; and
updating, by the computer system based on the evaluating, metrics for events evaluated during the live test, the metrics including:
a first set of metrics for the events evaluated during the live test using the current set of event processing filters; and
a second set of metrics for the events evaluated during the live test using the first new set of event processing filters;
wherein the first set of metrics and the second set of metrics are updated using information generated external to the event processing system.

2. The method of claim 1, wherein the selected set of event processing filters includes a particular event processing filter that is not present in any of remaining ones of the plurality of sets of event processing filters, and wherein evaluating the live event includes determining whether to allow a transaction based on the live event to be processed based on results of applying the selected set of event processing filters to the live event.

3. The method of claim 1, wherein, over a duration of the live test, the computer system splits a stream of live events that includes the live event into at least two sub-streams that includes a first sub-stream evaluated according to the current set of event processing filters and a second sub-stream evaluated according to the first new set of event processing filters, wherein the stream is split according to a specified split parameter.

4. The method of claim 3, wherein the selected set of processing filters is determined for the live event by hashing metadata in the event details into a particular one of a plurality of bins corresponding to the first new set of processing filters, a size of the particular bin being determined based on the specified split parameter.

5. The method of claim 1, further comprising receiving, from a computing device of a user of the event processing system, a request to render, on the computing device, a dashboard that displays visual representations of the first set of metrics and the second set of metrics.

6. The method of claim 1, further comprising:
receiving, from a computing device of a user of the event processing system, an indication to promote the first new set of event processing filters to become the current set of event processing filters.

7. The method of claim 1, wherein the plurality of sets of event processing filters includes a second new set of event processing filters, the metrics including a third set of metrics for events evaluated during the live test using the second new set of events processing filters.

8. The method of claim 1, further comprising making further updates to the metrics based on information regarding the live event that is received after conclusion of the live test.

9. The method of claim 1, wherein the event processing system is a system configured to classify computer security alerts within a computer network, the live event corresponding to a particular security event.

10. The method of claim 1, wherein the event processing system is a system configured to evaluate e-commerce transactions, the live event corresponding to a particular e-commerce transaction.

11. A non-transitory, computer-readable medium storing program instructions that are executable on a computer system of an event processing system to perform operations that comprise:
receiving, during a live test of a first new set of event processing filters, event details for a live event;
determining a selected set of processing filters to use in evaluating the live event, wherein the determining is performed between a plurality of sets of event processing filters that includes a current set of event processing filters and the first new set of event processing filters;
evaluating the live event according to the selected set of event processing filters; and
updating, based on the evaluating, metrics for events evaluated during the live test, the metrics including:
a first set of metrics for events evaluated during the live test using the current set of event processing filters; and
a second set of metrics for events evaluated during the live test using the first new set of event processing filters; and
wherein the first set of metrics and the second set of metrics are updated using information generated external to the event processing system.

12. The non-transitory, computer-readable medium of claim 11, the operations further comprising:
receiving, from a user of the event processing system, first input data that causes the computer system to commence the live test; and
receiving, from the user after conclusion of the live test, second input data which causes the computer system to promote the first set of new event processing filters to the current set of event processing filters for subsequent evaluation of live events.

13. The non-transitory, computer-readable medium of claim 12, wherein the operations further comprise:
receiving, from the user, a request to view a dashboard that displays visual representations of the first set of metrics and the second set of metrics.

14. The non-transitory, computer-readable medium of claim 11, wherein the operations further comprise continuing to update the first set of metrics and set of metrics in response to receiving, after conclusion of the live test, additional information about live events in the live test.

15. The non-transitory, computer-readable medium of claim 11, wherein the plurality of sets of event processing filters further includes a second new set of event processing filters, and wherein the determining includes splitting, according to split parameters, live events in the live test between the current set of event processing filters, a first new set of event processing filters, and a second new set of event processing filters.

16. A method, comprising:
performing, by a computer system of an event processing system, a live test of a plurality of sets of event processing filters that includes a current set of event processing filters and a first new set of event processing filters, wherein the performing includes:
splitting, according to a specified split parameter, live event data received during the live test into a first set of live event data and a second set of live event data;
evaluating the first set of live event data using the current set of event processing filters;
updating a first set of metrics for the first set of live event data;
evaluating the second set of live event data using the first new set of event processing filters; and
updating a second set of metrics for the second set of live event data; and
receiving, by the computer system, a request from a computing device of a user of the event processing system to render, on a display of the computing device, a dashboard that includes visual representations of a set of metrics that includes the first set of metrics and the second set of metrics; and
wherein the first set of metrics and the second set of metrics are updated using information generated external to the event processing system.

17. The method of claim 16, wherein evaluating the first set of live event data includes determining whether to process transactions corresponding to live events in the first set of live event data using the current set of event processing filters, and wherein evaluating the second set of live event data includes determining whether to process transactions corresponding to live events in the second set of live event data using the first new set of event processing filters.

18. The method of claim 17, wherein the splitting includes:
receiving, during the live test, particular live event data for a particular live event;
hashing metadata in the particular live event data into a particular one of a plurality of bins corresponding to the plurality of sets of event processing filters, the particular bin indicating which set of event processing filters is to be used to evaluate the particular live event data, wherein the hashing is performed to achieve a percentage distribution of live event data that is indicated by the specified split parameter.

19. The method of claim 18, wherein the plurality of sets of event processing filters includes a second new set of event processing filters, wherein the performing includes:
splitting, according to the specified split parameter, live event data received during the live test into the first set of live event data, the second set of live event data, and a third set of live event data;
evaluating the third set of live event data using a second new set of event processing filters; and
updating a third set of metrics for the third set of live event data.

20. The method of claim 17, further comprising:
updating, after the live test has ended, the first set of metrics and the second set of metrics with additional information about live events in the live test.
